(19) United States
(12) Patent Application Publication
(10) Pub. No.: US 2016/0339376 A1
(43) Pub. Date: Nov. 24, 2016

(54) DECOMPOSABLE AIR FILTER AND METHOD FOR MANUFACTURING SAME

(71) Applicant: Delta M Incorporated, Milton (CA)

(72) Inventors: Edward George Magee, Mississauga (CA); John Magee, Campbellville (CA)

(21) Appl. No.: 15/160,283

(22) Filed: May 20, 2016

Related U.S. Application Data
(60) Provisional application No. 62/165,576, filed on May 22, 2015.

(51) Int. Cl. B01D 46/00

(52) U.S. Cl. CPC B01D 46/0015; B01D 46/0001

(57) ABSTRACT

A novel air filter comprises a frame having at least a perimeter portion and a generally open central area. An air filtering member of decomposable organic fibrous material is securely retained by the frame across the generally open central area, to thereby permit filtering of air passing through the generally open central area. The frame member may also be constructed from a decomposable organic fibrous material or from a decomposable plastics material.

### FIELD OF THE INVENTION

The present invention relates to air filters for use in HVAC systems, and more particularly to air filters for use in HVAC systems wherein the air filtering member of the air filter is decomposable.

### BACKGROUND OF THE INVENTION

The use of air filters placed throughout the ductwork in heating, ventilation and air conditioning (“HVAC”) systems is well known. Air filtration may be required in buildings with HVAC systems to abide by health and safety regulations. Filters may not only improve air quality by removing harmful contaminants for the sake of health of the building's occupants, but may also help prevent fouling and failure of HVAC equipment. Indoor air quality may be correlated to the particulate and contaminant levels in the air stream in residential, industrial and commercial buildings. Air filters may remove, for example, dust, pollen, mold, and bacteria from the air passing therethrough, thus preventing discharge of such pollutants from the vents of the HVAC system, and into work and living areas.

The average useful life of an air filter may significantly vary due to the pollutant level. For example, the average useful life of a standard residential air filter may range approximately from one to three months.

The filtration media used in such air filters commonly may have been a woven or non-woven fibrous material such as, for example, various types of polyester, glass fibers and the like. Such media typically may have had a relatively open matrix of fibers arranged to provide for the free flow of air therethrough, while at the same time operating to physically entrain the contaminants present in the incoming air.

Now, to the extent that prior art air filter products, such as polyester air filters, may have been manufactured from petroleum-based products, they may become more expensive as oil prices rise and/or may have even more limited recycling avenues.

Prior art air filters commonly may have been of the single use variety, in that they were discarded without washing once their capacity was reached, or in other words once acceptable flow rates of air therethrough were no longer attainable. This may have typically occurred when the fiber matrix of the filtration media became substantially clogged with contaminants.

Prior art filters, at the end of their life, may have been sent into the refuse stream. Disposal of such air filters may contribute a significant amount of waste to municipal refuse streams. They may accumulate in landfills and/or may be resistant to microbial breakdown. Obviously, the utilization of single-use air filters may result in a great deal of waste, which may be ecologically undesirable. The amount of waste produced by disposal of spent filters may be a problem with impacts on the environment and/or inhabitants associated therewith. It may be desirable to reduce the volume of this refuse stream.

Various regulations may seek to limit human impact on the environment and/or to encourage development of environmentally-friendly solutions. A growing number of companies may begin to consider alternatives to their waste disposal methods.

Accordingly, attempts may have been made to develop filters that can be reused and/or recycled, so as to lessen waste.

Some prior art air filters can be reused, thereby lessening waste. Typically, reusable air filters may be washed once their capacity has been reached, or possibly even somewhat before their capacity has been reached. However, ultimately, even reusable air filters may end up in landfill sites.

A washable re-usable filter is disclosed in U.S. Published Patent Application US 2008-0066436 A1, published Mar. 20, 2008, entitled Air Filter Apparatus, and in published Canadian Patent Application No. 2,560,483 published Mar. 14, 2008, entitled Recyclable Air Filter Apparatus For Use In HVAC Systems. These two published patent applications share common inventors with the present application, and their teachings are hereby incorporated herein by reference. In these prior art applications, the washable filter is provided as an apparatus with multiple components. These components include a rigid frame and an air filtering member releasably attachable thereto. The washable filter is disassembled and the air filtering member is removed and washed. The rigid frame may also be washed or otherwise cleaned. The washable filter is then re-assembled for re-use. While the washable re-usable filters just mentioned may reduce, over their useful service life, the total amount of non-decomposable waste that would be otherwise produced by the plurality of single-use filters they replace, they may eventually themselves end up as non-decomposable waste destined for disposal in landfill sites. Moreover, the repeated washing of these re-usable filters with strong detergents may not be without a negative environmental impact.

Accordingly, it may be an object of the present invention to provide an air filter wherein at least the air filtering member of the air filter is made from a decomposable organic fibrous material.

It may be desirable, according to the invention, to provide a natural fiber filter which help may push towards sustainability with biodegradable properties.

It may an object of one aspect of the invention to provide an air filter wherein at least the air filtering member of the air filter is made from a decomposable organic grass-based fibrous material, preferably, for example, from bamboo, hemp, flax and/or miscanthus.

Quite apart from the field of filtration media, hemp and flax sheet material goods—including, for example, low density 500 grams per square meter (“gsm”) hemp material, high density 750 gsm hemp, low density 300 gsm flax, 450 gsm flax, and high density 600 gsm flax sheet material goods—may have been used in one or more non-analogous fields of art, such as, for example, as media used in the field of embankment erosion control construction and maintenance.

It may an object of one aspect of the invention to provide an air filter wherein at least the air filtering member of the air filter is made from a decomposable organic grass-based fibrous hemp and/or flax sheet material.

It may be desirable to provide a completely biodegradable HVAC air filter fabricated from natural fibres as a viable alternative for filtration. As a viable substitute to petroleum-based prior art filters, filters provided according to the invention may be a preliminary step in solving increasing waste generation problems.

To use natural fibres as a filter material, it may be desirable for them to meet all applicable guidelines and standards for filter materials, including performance testing pursuant to the American Society of Heating, Refrigeration and Airconditioning Engineers (“ASHRAE”) 52.2 Guidelines/Standards.

It may be an object of one aspect of the present invention to provide an air filter, wherein both the air filtering member and the frame are each made from a decomposable material.

It may be an object of one aspect of the present invention to provide an air filter, wherein both the air filtering member and the frame are each made from a decomposable organic fibrous material.

It may be an object of one aspect of the invention to provide an air filter wherein, with or without the frame thereof, the air filtering member thereof may be macerated and/or chipped for use as a decomposable organic fibrous filler in fertilizer and/or other like products.

In one or more filters provided according to the present invention, it may also be desirable to utilize natural fibers which may be sourced locally and/or from widely-available crops and/or sheet materials.

It is an object of the present invention to obviate or mitigate one or more disadvantages and/or shortcomings associated with the prior art, to meet or provide for one or more needs and/or advantages, and/or to achieve one or more objects of the invention—one or more of which may preferably be readily appreciable by and/or suggested to those skilled in the art in view of the teachings and/or disclosures hereof.

### SUMMARY OF THE INVENTION

In accordance with one aspect of the present invention there is disclosed a novel air filter comprising a frame having at least a perimeter portion and a generally open central area, wherein an air filtering member of decomposable organic fibrous material is securely retained by the frame across the generally open central area so as to permit filtering of air passing through the generally open central area.

According to an aspect of the invention, the decomposable fibrous material comprises a grass-based fibrous material formed as a substantially flat sheet.

According to an aspect of the invention, the grass-based fibrous material includes at least one of bamboo, hemp, flax and miscanthus.

According to an aspect of the invention, the grass-based fibrous material may preferably include a low and/or high density hemp and/or flax material.

The hemp material, formed as the aforesaid sheet, may preferably have a weight in the range of between about 500 gsm and about 750 gsm. The flax material, formed as the aforesaid sheet, may preferably have a weight in the range of between about 300 gsm and about 600 gsm, or a weight of about 450 gsm.

According to another aspect of the invention, both the air filtering member and the frame are constructed from decomposable materials, although not necessarily the same decomposable materials.

According to another aspect of the invention, the frame is constructed from a decomposable plastic material.

In accordance with another aspect of the present invention there is disclosed a novel method of manufacturing an air filter. The method comprises the steps of reducing miscanthus into shivs; initially soaking a batch of the miscanthus shivs in water; placing the batch of soaked miscanthus into a container for subsequent cooking; adding an amount of water into the container such that the batch of miscanthus is covered by the water; adding an amount of sodium bicarbonate into the water, thereby producing a mixture of water, miscanthus and sodium bicarbonate; boiling the mixture in the container; cooling the mixture; straining the miscanthus from the mixture; rinsing the miscanthus with water; blending the rinsed miscanthus with water until the miscanthus and water form a pulp; adding an amount of water to a receiving bin; adding the pulped miscanthus into the water in the receiving bin; sieving out the pulp from the water; distributing the pulp generally uniformly to form a sheet of pulped miscanthus; placing the resulting sheet of pulped miscanthus onto a tray; and drying the sheet of pulped miscanthus.

These and other advantages, features and characteristics of the present invention, as well as methods of operation and manufacture and functions of the related elements, and the combination of parts and economies of manufacture, will become more apparent upon consideration of the following detailed description and the appended claims with reference to the accompanying drawings, the latter of which are briefly described hereinbelow.

### BRIEF DESCRIPTION OF THE DRAWINGS

The novel features which are believed to be characteristic of the air filter and method of manufacture according to the present invention, as to its structure, organization, use and method of operation, together with further objectives and advantages thereof, will be better understood from the following drawings in which one or more presently preferred embodiments of the invention will now be illustrated by way of example. It is expressly understood, however, that the drawings are for the purpose of illustration and description only, and are not intended as a definition of the limits of the invention. In the accompanying drawings:

FIG. 1 is a cut-away perspective view of a first illustrated embodiment of the air filter according to the present invention, installed in a furnace plenum;

FIG. 2 is an exploded perspective view of the first illustrated embodiment air filter shown in FIG. 1;

FIG. 3 is an exploded perspective view of a second illustrated embodiment air filter according to the present invention;

FIG. 4 is a front elevational view of the first illustrated embodiment air filter of FIG. 2, wherein the air filter has been used to filter dirty air;

FIG. 5 is front elevational view of a third illustrated embodiment of the air filter according to the present invention, wherein the air filter has been used to filter air;

FIG. 6 is a graph illustrating estimated natural fibre removal efficiencies from a first set of tests performed by or on behalf of the inventors and/or applicant concerning various embodiments of air filters constructed according to the present invention;

FIG. 7 is a graph illustrating natural fibre removal efficiencies based on the first set of tests concerning various embodiments of air filters according to the present invention;

FIG. 8 is a graph illustrating clean filter pressure drop based on the first set of tests concerning various embodiments of air filters according to the present invention;

FIG. 9 is a graph illustrating estimated yearly operation cost based on the first set of tests concerning various embodiments of air filters according to the present invention;

FIG. 10 is a flowchart illustrating the method of manufacturing a preferred embodiment of air filter according to the present invention;

FIG. 11 is a graph illustrating estimated MERV ratings based on the first set of tests concerning various embodiments of air filters according to the present invention;

FIG. 12 is a graph illustrating filter resistance at variable airflow rates from a second set of tests performed by or on behalf of the inventors and/or applicant concerning various embodiments of flax air filters constructed according to the present invention;

FIG. 13 is a graph illustrating filter resistance at variable airflow rates from the second set of tests concerning various embodiments of hemp air filters constructed according to the present invention; and

FIG. 14 is a chart tabulating collection efficiency and MERV rating results from the second set of tests concerning various embodiments of flax and hemp air filters constructed according to the present invention.

### DETAILED DESCRIPTION OF THE PREFERRED EMBODIMENTS

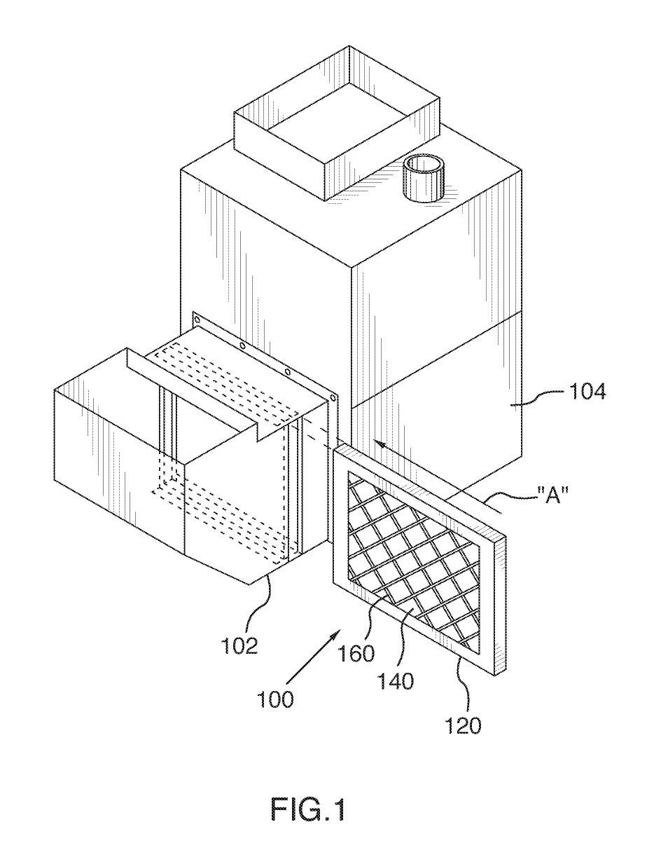

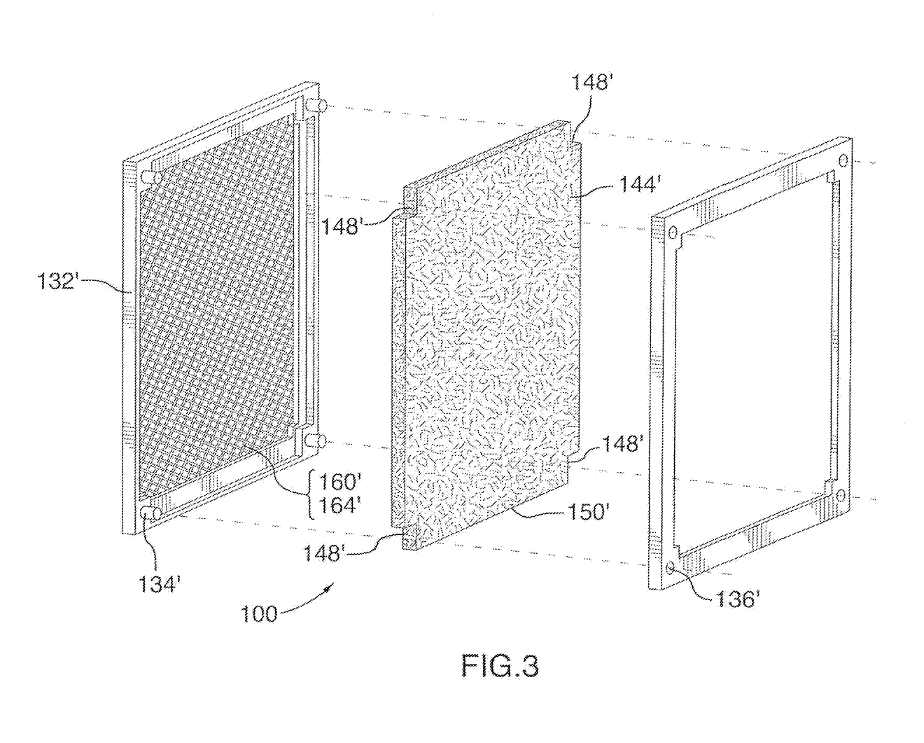

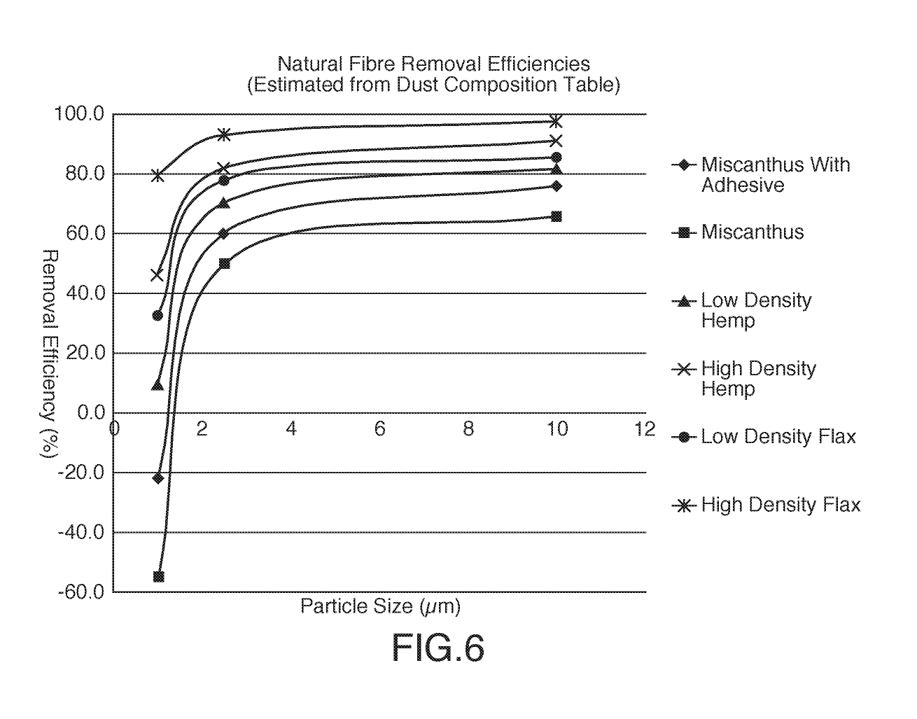

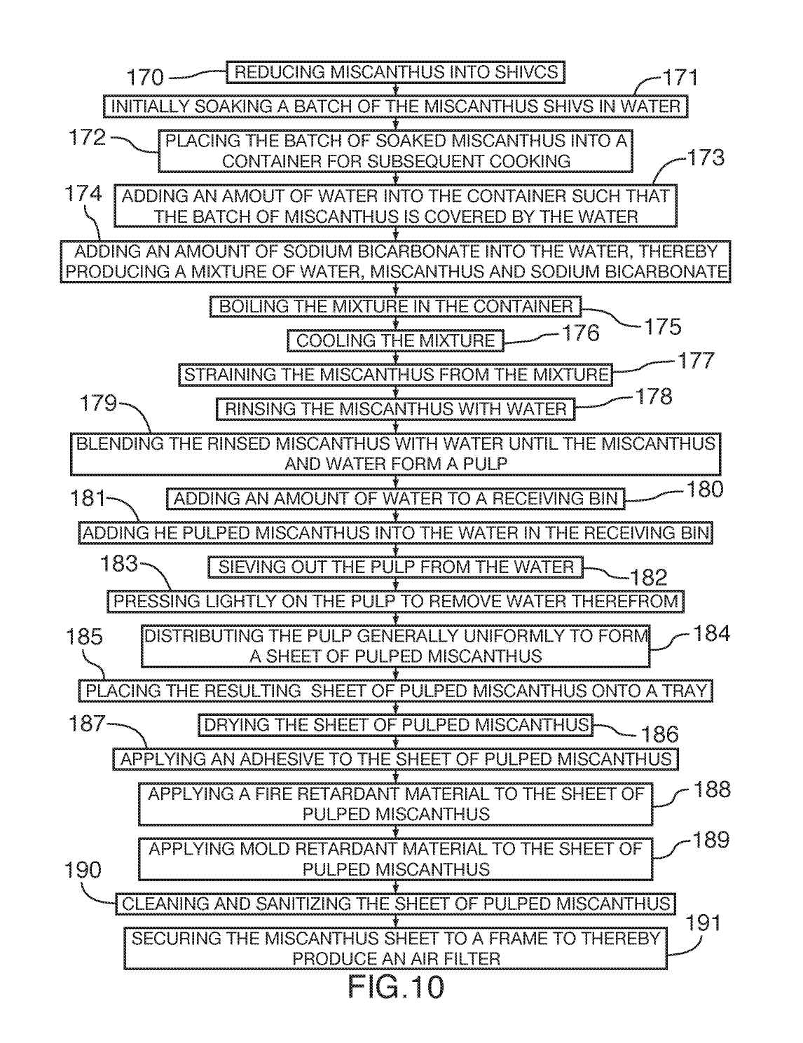

Referring to FIGS. 1 through 11 of the drawings, it will be noted that FIGS. 1, 2 and 4 illustrate a first embodiment of an air filter according to the present invention, FIG. 3 illustrates a second embodiment of an air filter according to the present invention. FIG. 5 illustrates a third embodiment of the air filter according to the present invention. FIGS. 6 through 9 and 11 are graphs illustrating characteristics determined based on a first set of tests performed by or on behalf of the inventors and/or applicant concerning various embodiments of the air filter according to the present invention, and FIG. 10 is a flowchart illustrating method of manufacturing the air filter according to the present invention.

Reference will now be made to FIGS. 1, 2 and 4, which show a first illustrated embodiment of the air filter 100 according to the present invention. In brief, the first illustrated embodiment of the present invention comprises an air filter 100 comprising a frame 120, an air filtering member 140, and a flow-through support member 160.

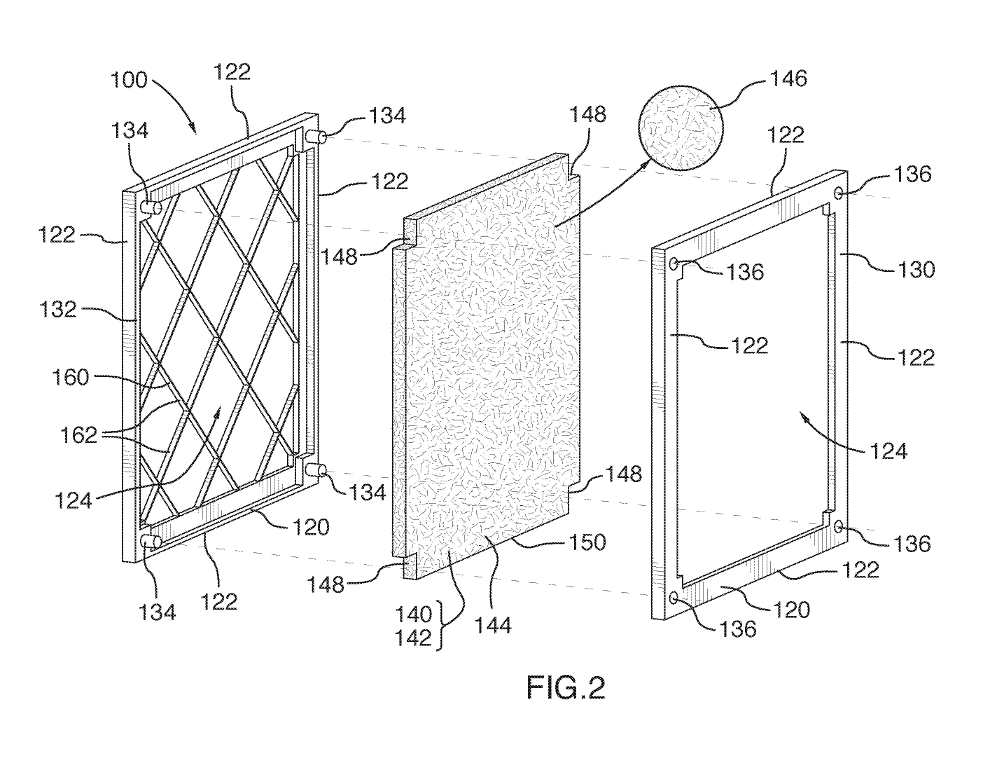

More specifically, the air filter 100 comprises the frame 120, which frame 120 has at least a perimeter portion 122 and a generally open central area 124 (see FIG. 2). The frame 120 is typically substantially square or rectangular, and in the first illustrated embodiment illustrated, is substantially rectangular. The frame 120 may alternatively be any other suitable shape as required. Preferably, the frame 120 is made from a decomposable type of plastics material. Also preferably, as presently known to the inventor, the decomposable type of plastics material comprises polylactic plastic (PLA). Alternatively, the frame 120 can be made from other suitable decomposable types of material, such as, for example, a grass-based fibre material, such as miscanthus, bamboo, hemp, and/or flax, and/or combinations thereof, or from stiffened paper or cardboard.

The air filtering member 140 is retained by the frame 120 so as to be situated in extended relation across the generally open central area 124, to permit air flow therethrough when the air filter 100 is in place in an air plenum 102, or the like, connected in fluid communication with a furnace 104, or air conditioner or heat pump (not specifically shown), as appropriate, in a HVAC system. Such placement of the air filtering member 140 (as indicated by arrow “A” in FIG. 1) permits filtering of air passing through the generally open central area 124 of the frame 120.

As can be best seen in FIG. 2, the frame 120 comprises an upstream portion 130 and a downstream portion 132. The air filtering member 140 is disposed between the upstream portion 130 and the downstream portion 132, and is securely retained between the upstream portion 130 and the downstream portion 132 of the frame 120. One of the upstream portion 130 and downstream portion 132 of the frame 120, specifically the downstream portion 132 in the first illustrated embodiment, has a plurality of connector posts 134, specifically four connector posts 134, one connector post adjacent each corner of the rectangular frame 120. The other one of the upstream portion 130 and the downstream portion 132, specifically the upstream portion 130 in the first illustrated embodiment, has an equal plurality of receiving sockets 136, specifically four receiving sockets 136 positioned, shaped and dimensioned to receive and retain the connector posts 134 therein. The connector posts 134 are received and retained in frictional engagement by the receiving sockets 136. Adhesive may be optionally used to assist with such retainment.

The connector posts 134 are disposed one adjacent each of the four corners of the downstream portion 132 of the frame 120 and the receiving sockets 136 are disposed one adjacent each of the four corners of the upstream portion 130 of the frame 120.

The air filtering member 140 preferably has apertures 148 therein for receiving the connector posts 134 therethrough. As illustrated, the apertures 148 comprise notches disposed at the outer peripheral edges 150 of the air filtering member 140.

The air filtering member 140 is made from a decomposable organic fibrous material. In the first illustrated embodiment, the decomposable organic fibrous material used to form the air filtering member 140 preferably comprises a grass-based fibre material formed as a sheet 142. The grass-based fibrous material preferably includes at least one of bamboo, hemp, flax and miscanthus. In the first illustrated embodiment, the grass-based fibrous material may preferably comprise miscanthus, which is a type of perennial grass native to various subtropical and tropical regions.

Typically, miscanthus grows to a height of about three meters, or even more, and therefore it may be desirable to reduce the miscanthus into pieces, commonly known as shivs, by an operation such as cutting and/or milling. Preferably, the miscanthus shivs 146, as best seen in the enlarged circle portion of FIG. 2, which may be used in some preferred embodiments of the present invention, may have a length of about five millimeters to about fifteen millimetres. Further, the miscanthus shivs 146 preferably contain the entire miscanthus stock including the outer epidermis, the pith, the leafy part, the epithelial and/or parenchyma cells, the various fibers, and/or the cortex, all of which preferably are readily decomposable when buried.

According to some embodiments of the invention, the air filtering member 140 (that may preferably have been formed into a sheet 142) may preferably be formed from miscanthus pulp. The various miscanthus shivs 146 preferably may be arranged substantially randomly during pulp formation, and/or the air filtering member 140 formed therefrom is preferably a felted type of material, laid down from such pulp using paper-making like procedures.

The air filtering member 140 may also be made from other decomposable organic fibrous materials such as bamboo, hemp and flax. For example, in the case of bamboo, it may be desirable to use the centre part of the bamboo, without the outer wall, according to some preferred embodiments of the invention. As a further or alternate example, in the first illustrated embodiment, the grass-based fibrous material may preferably also or instead comprise: (i) a low and/or high density hemp material, formed as the sheet 142, which has a weight of about 500 gsm or about 750 gsm; and/or (ii) a low and/or high density flax material, formed as the sheet 142, which has a weight of about 300 gsm, about 450 gsm or about 600 gsm. The use of each of these materials, either alone or in combination, may produce results comparable to using miscanthus, although the use of miscanthus, according to some of the testing conducted to date by or on behalf of the inventors and/or applicant, may be preferable in some respects, for example, perhaps in terms of one or more filtering properties, as may be discussed and/or suggested in greater detail elsewhere herein. Moreover, miscanthus may be readily more available in certain tropical and sub-tropical regions, where it grows locally in abundance without other significant uses, therefore being readily available for use in the present invention. As such, it may be very economical to source in such regions, where such sourcing may additionally provide a significant benefit to local residents of these regions.

Preferably, miscanthus used to form the air filtering member 140 in the first illustrated embodiment of the present invention, may be boiled, rinsed after it has been boiled, and cleaned and sanitized. One presently known method of manufacturing the air filter 100 according to the present invention using a miscanthus air filtering member 140, is described subsequently.

Further, the present invention optionally comprises an adhesive 144 added to the sheet 142 of decomposable organic fibrous material, preferably as an outer layer on the sheet 142. It has been found that spraying the adhesive 144 onto the exterior surface of the sheet 142, preferably on the upstream exterior surface of the sheet 142, works to improve the filtering performance of the filtering member 140. In another embodiment, specifically the third illustrated embodiment as shown in FIG. 5, the miscanthus air filtering member 140″ does not have adhesive applied to it.

In the first illustrated embodiment, the sheet 142 of grass-based fibrous material is substantially flat, as this shape is easiest to initially form. Comparably, the sheet 142 of grass-based fibrous material preferably can be folded, ribbed, and/or pleated, in order to maximize the surface area of the air filtering member 140, while maintaining sufficient air flow therethrough. Such folding, ribbing and/or pleating preferably prolongs the intervals between replacement of the air filter 100. Also, needling of the sheet 142 using a needle loom (not shown) and a decomposable natural thread, such as a cotton thread (not shown), may be desirable to bind the fibres of the sheet together. Such needling, which may be entirely optional, may preferably reinforce the filtering member 140 against an active airflow, preferably thereby improving the integrity of the sheet 142 and/or prolonging the service life of the air filter 100.

The air filter 100 preferably further comprises the flow-through support member 160 positioned in the generally open central area 124 of the frame 120 in contacting relation with the air filtering member 140, to preferably thereby support the air filtering member 140 against the flow of air through the air filtering member 140. It should be understood that although the air filtering member 140 is preferably at least somewhat rigid, it may not be specifically required to be rigid or built overly robust, as it is preferably porous enough to permit air to freely flow therethrough. Accordingly, the flow-through support member 160 has been found to be useful and/or preferable in generally structurally supporting the air filtering member 140, and/or in protecting the air filtering member 140 from damage.

In the first illustrated embodiment, the flow-through support member 160 preferably comprises support portions 162 spanning across the generally open central area 124. As can be best seen in FIG. 2, the support portions 162 preferably comprise cross-braces. In the first illustrated embodiment, the flow-through support member 160 is preferably integrally formed with the downstream portion 132 of the frame 120, preferably for the sake of manufacturing efficiency and convenience, and/or for cost reduction.

Alternatively, as can be seen in FIGS. 3 and 5, which respectively show a second and third illustrated embodiment of air filter 100′, 100″ according to the present invention, the flow-through support member 160′, 160″ can also or instead preferably comprise a discrete substantially rigid mesh 164′ and 164″, which mesh is preferably fastened to the downstream portion 132′, 132″ of the frame 120′, 120″ assembly of the filter 100′, 100″.

The flow-through support member 160 in the first illustrated embodiment is preferably made from a decomposable type of plastic material, which decomposable type of plastic material may be, or may comprise, polylactic acid (PLA).

According to the present invention, there is also disclosed a method of manufacturing an air filter 100, as shown in flow chart form in FIG. 10. The method preferably comprises the steps of reducing the miscanthus material that is used to make the air filtering member 140 into shivs 146 (step 170) by either milling the miscanthus stocks into shivs 146, or cutting the miscanthus stocks into shivs 146, or by any other suitable sizing operation. Preferably, the miscanthus stocks are reduced into shivs 146 having a length of about five millimetres to about fifteen millimetres.

The miscanthus shivs 146 are preferably initially whetted by soaking a batch thereof in a bath of water (step 171) for more than about two hours, and preferably can be soaked for periods of two days, and perhaps even longer, and still remain suitable for use.

The batch of soaked miscanthus is preferably thereafter placed into a container for subsequent cooking (step 172). An amount of water is preferably added into the container such that the batch of miscanthus is fully covered by the water (step 173). An amount of sodium bicarbonate (baking soda) is preferably added into the water (step 174), thereby producing a mixture of water, miscanthus and sodium bicarbonate.

The mixture in the container is preferably then boiled (step 175), preferably on a low boil for two to three hours. Preferably, the mixture is then cooled (step 176), preferably in ambient surroundings at room temperature, preferably without the aid of a cooling apparatus.

The miscanthus is then preferably strained from the mixture (step 177), using any suitable straining device, and is rinsed with water. Preferably, the miscanthus is rinsed (step 178) with plain water until the water coming out of the bottom of the straining device is clear.

The rinsed miscanthus is then preferably blended with water until the miscanthus and water form a pulp (step 179). Preferably, the blending of the miscanthus with water is done to a ratio of about 1:1. Also, preferably the step of blending the miscanthus with water is performed in a blender.

An amount of water is then preferably added into a receiving bin (step 180), and the pulp miscanthus is also added into the water in the receiving bin (step 181). The pulp is then preferably sieved out of the water (step 182), preferably using a deckle screen. In conjunction with the step of sieving out the pulp from the water, there can be an additional/preferable step of pressing lightly on the pulp to remove the water therefrom (step 183).

The pulp is then preferably distributed generally on the sieve to form the sheet of pulped miscanthus (step 184). The resulting sheet of pulped miscanthus is then preferably placed onto a tray (step 185), and the sheet of pulped miscanthus is dried (step 186) to form the resulting sheet 142 that constitutes the air filtering member 140.

The method preferably further comprises an additional or alternate step of applying an adhesive 144 to the sheet 142 of pulped miscanthus (step 187), preferably by spraying adhesive 144 onto the sheet 142 of pulped miscanthus. Other optional steps preferably include applying a fire retardant material to the sheet 142 of pulped miscanthus (step 188), applying a mold retardant to the sheet 142 of pulped miscanthus (step 189), and cleaning and sanitizing the sheet 142 of pulped miscanthus (step 190).

Once the sheet 142 of pulped miscanthus is dry, and any other subsequent steps have been taken to put the sheet 142 in its final physical form (e.g., needling, cutting, pleating, folding, etc.), the next step is preferably to secure the finished miscanthus sheet to a frame 120. More specifically, as can be envisioned in FIG. 2, the air filtering member 140 is preferably securely retained between the upstream portion 130 and the downstream portion 132 of the frame 120, as the upstream portion 130 and the downstream portion 132 are brought together and secured to each other, preferably to thereby produce the air filter 100.

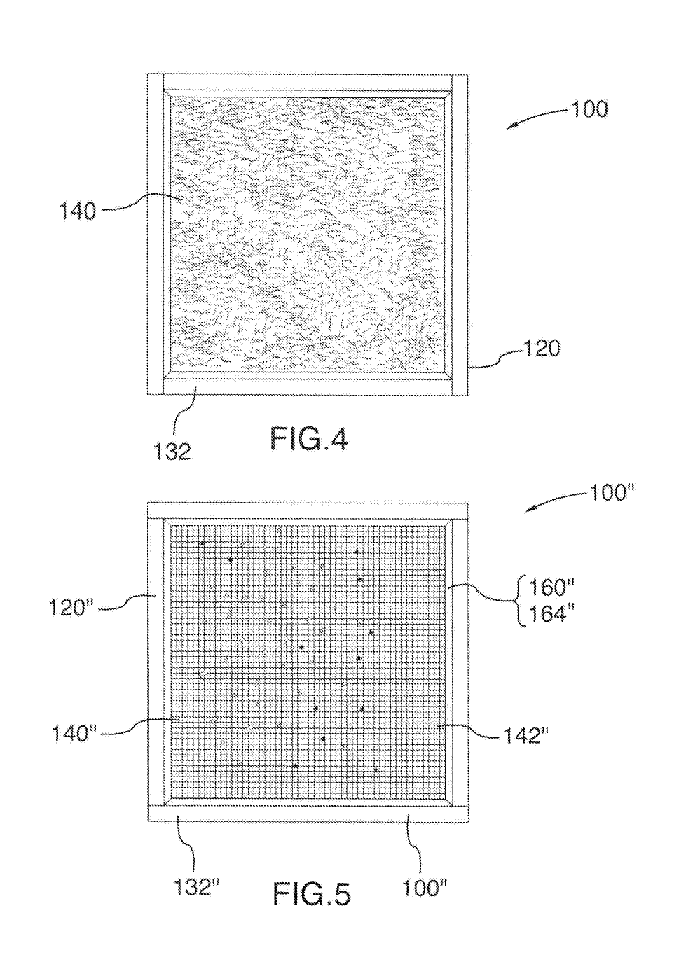

In use, the air filter 100 is preferably placed into the air plenum 102 (as shown in FIG. 1), which plenum is preferably connected in fluid communication with the furnace 104 in a conventional HVAC system. It has been found through systematic testing, that the first illustrated embodiment of the air filter 100, wherein the air filtering member 140 is made from miscanthus and has the outer layer of adhesive 144 (or made from hemp or flax sheet material), is preferable and/or very effective at filtering air forced through the HVAC system. As can be seen in FIG. 4, which shows the first illustrated embodiment air filter 100 with adhesive on the miscanthus air filtering member 140, a substantial amount of airborne contaminants has preferably been trapped by the air filter 100. As can be seen in FIG. 5, which shows the third illustrated embodiment air filter 100″ without adhesive on the miscanthus air filtering member 140″, a significantly lesser amount of airborne contaminants has been trapped by the air filter 100″.

Standardized air filter tests were carried out by or on behalf of the inventors and/or applicant herein. A first set of these standardized air filter tests utilized filter media comprising miscanthus, miscanthus with adhesive, low density hemp, high density hemp, high density flax, low density flax and polyester sheet material (as a prior art control). The data collected from the first set of these tests is presented graphically in FIGS. 6 to 9 and 11.

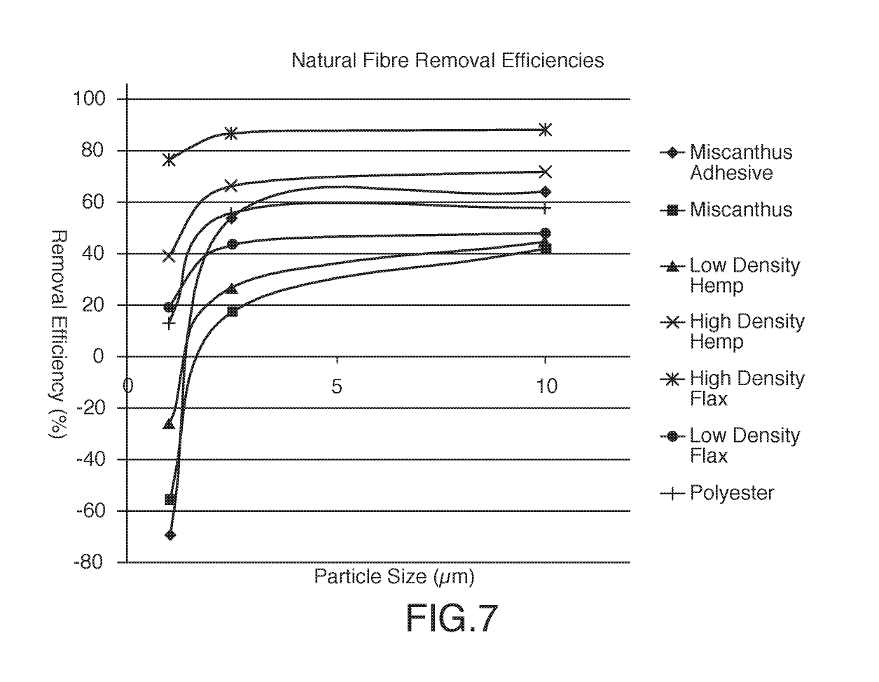

As can be appreciated from FIGS. 6 and 7, the air filter 100 made from miscanthus and having the outer layer of adhesive 144 may be an effective form of the air filter, with an estimated natural fibre removal efficiency of between 80% and nearly 100% for airborne particles from one (1.0) micrometer to ten (10.0) micrometers in size, respectively, as shown in FIG. 6, and a measured natural fibre removal efficiency of between just below 80% and about 90% for airborne particles from one (1.0) micrometer to ten (10.0) micrometers in size, respectively, as shown in FIG. 7. Similarly, other materials and combinations of materials may produce comparable efficiencies, even if slightly lower, perhaps depending (directly or indirectly) on particle size of the test dust entrained in the air flow passed through the filtering member upon testing, which testing was conducted according to ASHRAE Standard 52.2-2007, which standard is hereby incorporated by reference. In the first set of tests conducted by or on behalf of the inventors and/or applicant herein, six trials were conducted per filter: 2 trials for PM10; 2 trials for PM2.5; and, 2 trials for PM1. The prior art filtering member most commonly used is constructed from polyester sheet material, for which comparison data is also shown in FIGS. 7, 8 and 9.

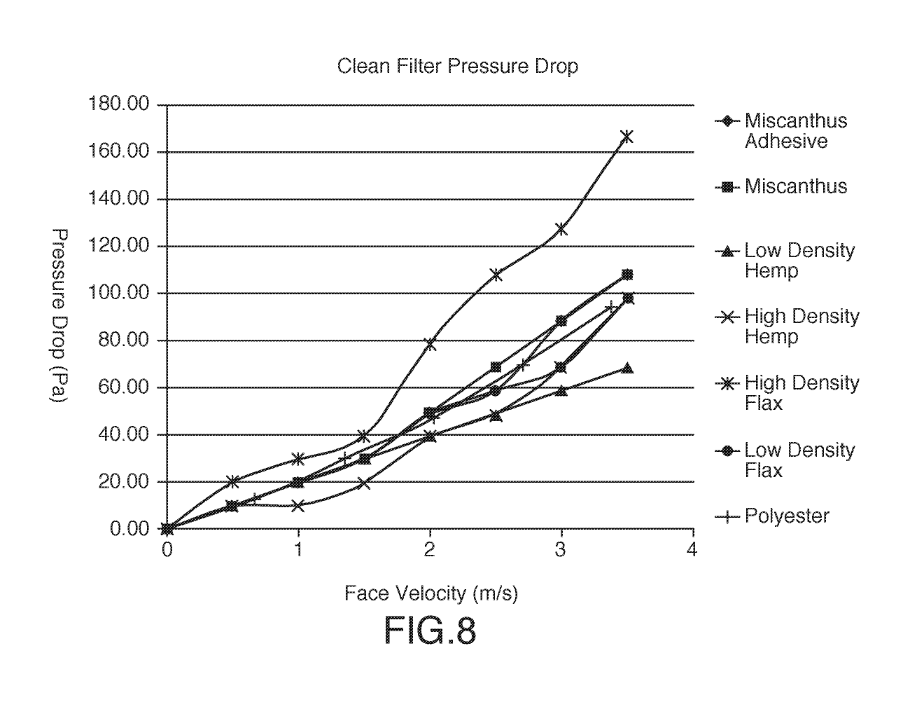

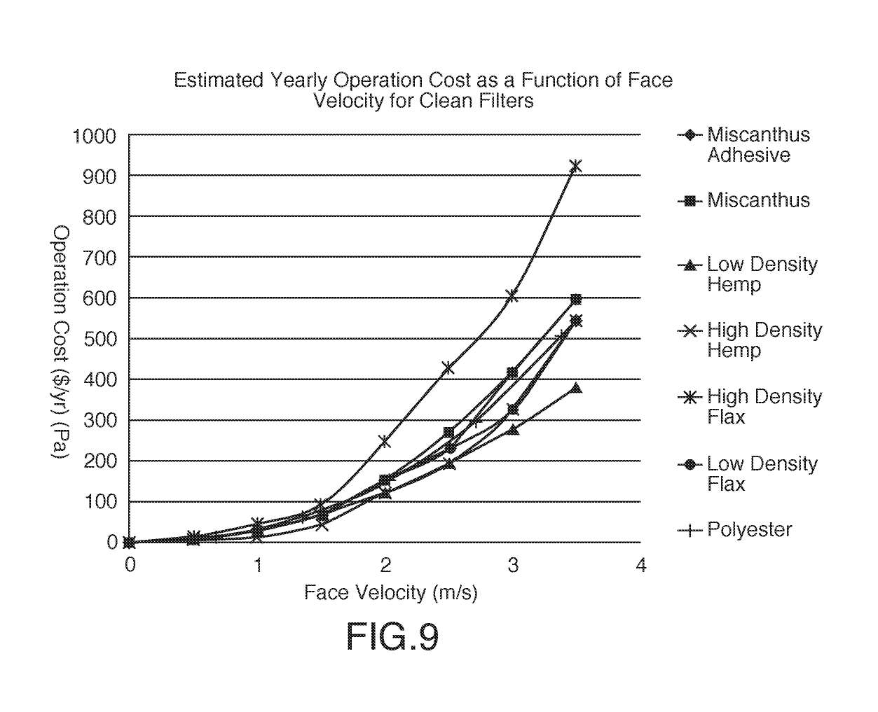

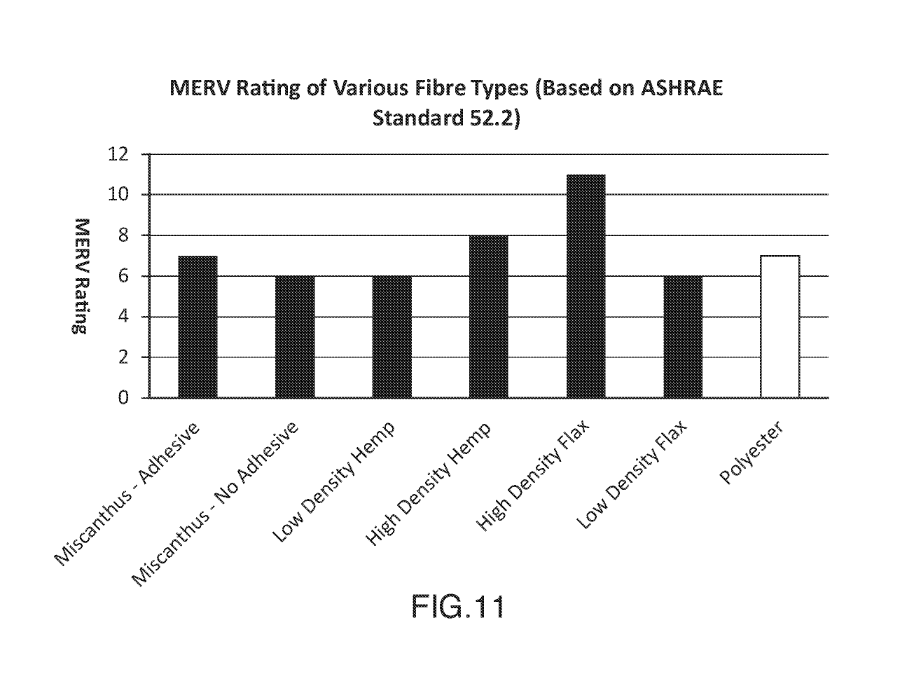

As can be appreciated from FIG. 8, the air filter 100 made from miscanthus and having an outer layer of adhesive 144 may, in keeping with the first set of tests, cause a pressure drop that is about the same as most of the other air filters. In the first set of tests, the high density flax air filter may have caused the greatest pressure drop, though such a pressure drop may be somewhat less than ideal, at least perhaps in some respects. Corresponding to the pressure drops, as shown in FIG. 8 (and as based on the first set of tests), the yearly operating costs, as illustrated in FIG. 9, are shown to be somewhat similar for most of the air filters, with the high density flax air filter showing perhaps the greatest variance in this respect. FIG. 11 shows estimated MERV ratings based on the first set of tests.

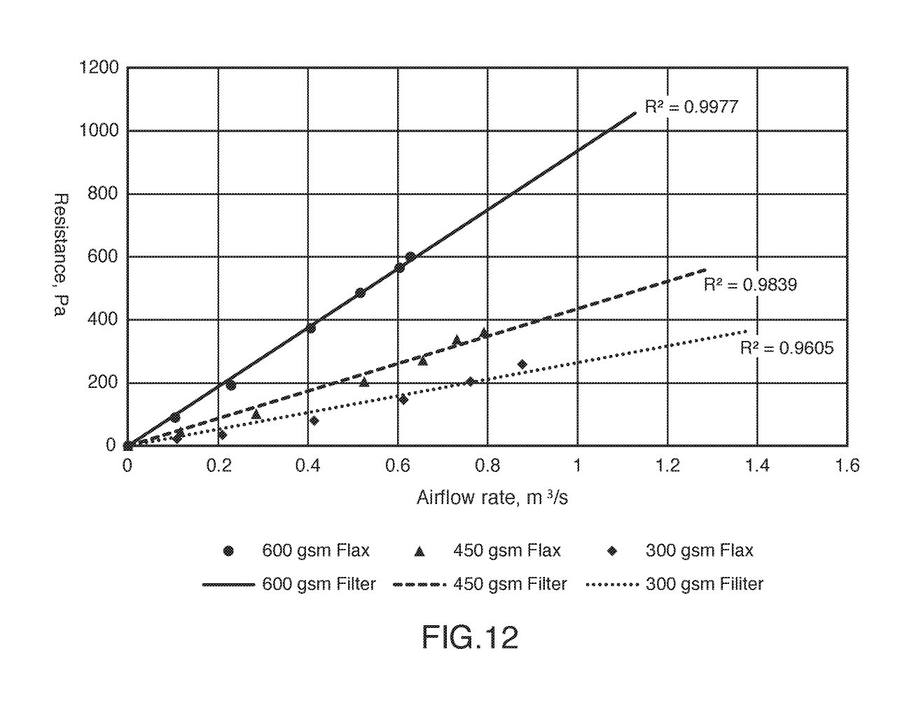

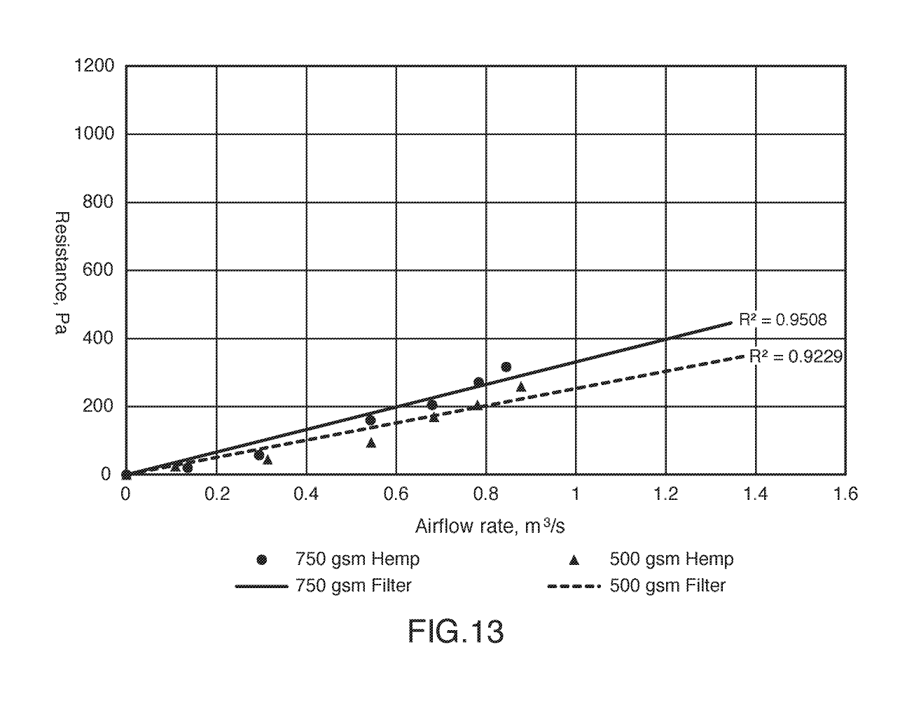

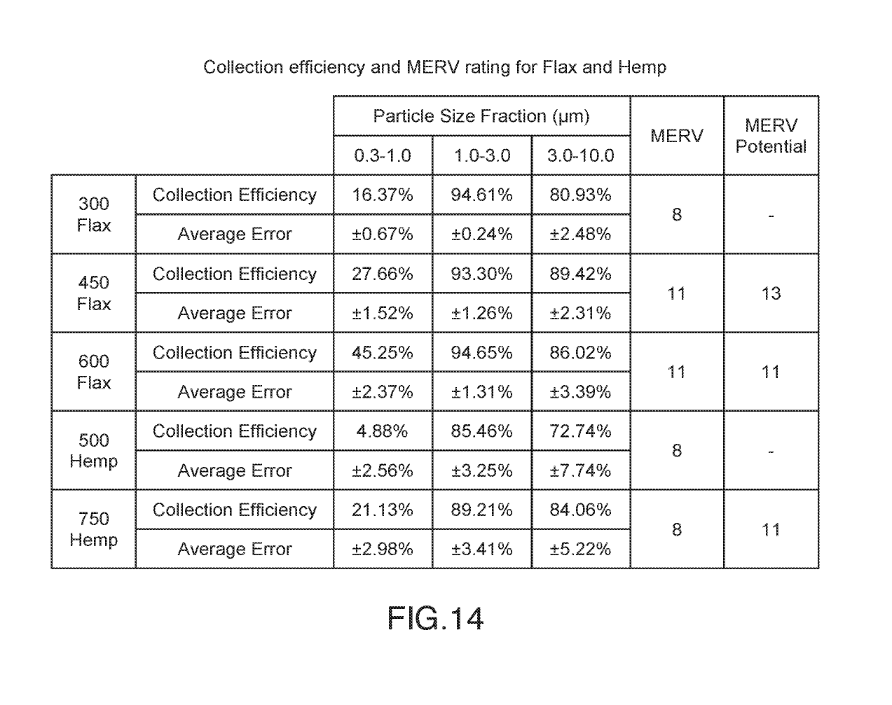

Referring to FIGS. 12 through 14 of the drawings, it will be noted that FIGS. 12 and 13 are graphs, and FIG. 14 is a chart, illustrating characteristics determined based on a second set of tests performed by or on behalf of the inventors and/or applicant concerning various embodiments of flax and hemp air filters according to the present invention. The second set of tests was conducted to examine particle collection efficiency of flax and hemp filter media as suitable substitutes for current filter media.

Flax and hemp filter media according to the invention are preferably biodegradable, and may reduce the impact of filter media on the waste stream and/or eliminate the need for synthetic products in air filtration. Preferably, flax and hemp source materials for such filter media may be grown and harvested sustainably, before being isolated into fibres and processed into filter media. That said, flax and hemp sheet materials goods—including, for example, low density 500 gsm hemp material, high density 750 gsm hemp, low density 300 gsm flax, 450 gsm flax, and high density 600 gsm flax sheet material goods—may have been used in one or more non-analogous fields of art, such as, for example, as media used in the field of embankment erosion control construction and maintenance.

Though perhaps not essential to the working of the present invention, performance testing may indicate some of the best filter media according to the present invention. In this respect, Minimum Efficiency Reporting Values (“MERVs”) of the filter media may have been quantified and/or calculated, based on tests of capture efficiency using upstream and downstream particle concentrations. Similarly, the pressure ratings of the various filter media may have been quantified and/or calculated with a view to potential efficiency of the HVAC systems. Testing procedures and standard practices for the filter media according to the invention are preferably comparable to the ASHRAE Standard 52.2 for HVAC filtration. Thus—in the second set of tests conducted by or on behalf of the inventors and/or applicant on various flax and hemp filter media according to the invention—a testing chamber was constructed. The chamber was capable of adjusting the amount of particles being generated, the air stream velocities through the duct, inducing adequate mixing of the particles to ensure even concentrations, and measuring pressure gradients and other relevant data for analysis (e.g., upstream and downstream particle concentrations, pressure drop across the filter and flow rate of air stream). The second set of tests was with a view to evaluating various flax and hemp filter mats according to the invention, as based at least in part on their measured MERV. The testing procedure followed the methodology outlined by ASHRAE 52.2, to find the MERV ratings of certain flax and hemp filter mats according to the invention. The tested flax and hemp filter mats had varying weight densities, and included 300 gsm flax, 450 gsm flax, 600 gsm flax, 500 gsm hemp, and 750 gsm hemp.

FIGS. 12 to 14 graphically present and tabulate certain results, discussed hereinbelow, of the evaluated flax and hemp filters according to the invention. The analysis conducted focused on the resistance that the filters created, as well as the particulate concentrations upstream and downstream of the filter in size ranges of 0-1.0 micrometer (μm), 1.0-3.0 micrometers (μm), and 3.0-10.0 micrometers (μm).

A filter experiencing a higher resistance to air flow may require increased power generation to maintain the required flow rate. However, filter efficiency may be known to increase with filter resistance. Therefore, there may be a desired compromise between filter efficiency and the resistance for each of the filters. FIGS. 12 and 13 display the results of the pressure drop across the flax and hemp filter media, against the air flow rates, respectively. It can be seen that, in the second set of tests, the trend displayed by both hemp and flax filter media according to the invention may have been substantially linear, indicating that, with increasing flow rate, the resistance of the filter may also increase.

Results for collection efficiency and final MERV are shown in FIG. 14. The results appear to show that increasing the weight density with both flax and hemp filter media may sometimes (but not always) tend to increase the collection efficiency. (See, for example, the MERV ratings for the different weight densities of hemp filter media in FIG. 14.)

Generally then, it may be noted from FIGS. 12 to 14 that both flax and hemp filters performed well in comparison to the current filters in residential and industrial applications, reporting a minimum MERV of 8, and a maximum of 11. The second set of tests suggests that particle capture efficiency may be higher for mid-range particles than for larger particles, depending on whether flax and/or hemp filter media may preferably be used according to the invention.

An air flow indicator means (not shown) may also be advantageously mounted on the downstream portion 132 of the frame 120 to provide an indication that a change of the filter 100 is recommended. Such an air flow indicator may in its simplest form be a pivot arm mounted adjacent its upper end on the frame 120 (or on one or more of the flow-through support members 160) for vertically pivoting movement. In this manner, the indicator arm projects downwardly into the path of the airflow and is raised on the downstream side of the filter 100 by air passing through the filtering member 140. Thus, the degree of lifting of the pivot arm is directly proportional to the air flow passing through the filter from the upstream side to the downstream side. The pivot arm and scale could advantageously be constructed from a decomposable type of plastics material, including, but not limited to polylactic acid (PLA).

The air flow indicator could be completely manual, in which case a user could observe that the pivot arm had fallen, thereby indicating a lack of air flow consistent with a dirty filtering member 140 blocking air flow. In such case, an air flow indicator scale (having either coloured zones or other markings) could be further provided as part of air flow indicator means to allow the user to form an objective determination of the acceptability of the observed air flow as indicated by the relative vertical position of the lever arm as against the markings on the indicator scale. In a further automated embodiment (not shown), dropping of the pivot arm a measured degree could cause the lever arm to close an electric circuit that would send a signal to an alarm system, in turn sending a visible or auditory alarm signal to a user to change the filter 100. Such a system could be AC hard wired into the air plenum 102 of the furnace 104, or could be battery operated.

Preferably, according to the invention, at the end of a decomposable and/or biodegradable natural fiber filter's useful life, it might then be composted or used as a fertilizer filler, either of which in turn could be returned as a soil amendment and/or assist in the growth of additional plant matter. Preferably, the air filtering member of the air filter according to the invention (with or without the frame thereof) may be macerated and/or chipped for use as a decomposable organic fibrous filler in fertilizer and/or other like products.

As will be understood from the above description and from the accompanying drawings and data, the present invention provides an air filter, wherein at least the air filtering member of the air filter is made from a decomposable organic fibrous material and wherein both the air filtering member and the frame may each be made from a decomposable material. Moreover, the dust removal performance and operating cost efficiencies of the air filters of the present invention are comparable with, or better than, disposable prior art air filters having filtering members constructed from non-decomposable material, such as polyester sheet material.

This concludes the description of several exemplary embodiments of the invention. The foregoing description has been presented for the purpose of illustration and is not intended to be exhaustive or to limit the invention to the precise form disclosed.

Naturally, in view of the teachings and disclosures herein, persons having ordinary skill in the art may appreciate that alternate designs and/or embodiments of the invention may be possible (e.g., with substitution of one or more components or steps for others, with alternate configurations of components and steps). Although some of the components, relations, configurations and/or steps according to the invention are not specifically referenced in association with one another, they may be used, and/or adapted for use, in association therewith. All of the aforementioned, depicted and various structures, configurations, relationships, utilities and the like may be, but are not necessarily, incorporated into and/or achieved by the invention. Any one or more of the aforementioned structures, configurations, relationships, utilities and the like may be implemented in and/or by the invention, on their own, and/or without reference, regard or likewise implementation of any of the other aforementioned structures, configurations, relationships, utilities and the like, in various permutations and combinations, as will be readily apparent to those skilled in the art, without departing from the pith, marrow, and spirit of the disclosed invention.

Other modifications, variations and alterations may be used in the design, manufacture, and/or implementation of other embodiments according to the present invention without departing from the spirit and scope of the invention, which is limited only by the claims appended below. The scope of the claims should not be limited by the embodiments set forth in the examples, but should be given the broadest interpretation consistent with the description as a whole.

We claim:

1. An air filter comprising:
a frame having at least a perimeter portion and a generally open central area; and,
an air filtering member of decomposable organic fibrous material securely retained by said frame across said generally open central area, to thereby permit filtering of air passing through said generally open central area.

2. The air filter of claim 1, wherein said decomposable organic fibrous material comprises a grass-based fibrous material formed as a sheet.

3. The air filter of claim 2, further comprising an adhesive added to said sheet of decomposable organic fibrous material.

4. The air filter of claim 3, wherein said adhesive comprises an outer layer on said sheet of decomposable organic fibrous material.

5. The air filter of claim 2, wherein said grass-based fibrous material includes at least one of bamboo, hemp, flax and miscanthus.

6. The air filter of claim 5, wherein said grass-based fibrous material comprises at least one of a low density hemp material and a high density hemp material.

7. The air filter of claim 5, wherein said grass-based fibrous material comprises a hemp material, formed as said sheet, having a weight in the range of between about 500 grams per square meter and about 750 grams per square meter.

8. The air filter of claim 5, wherein said grass-based fibrous material comprises at least one of a low density flax material and a high density flax material.

9. The air filter of claim 5, wherein said grass-based fibrous material comprises a flax material, formed as said sheet, having a weight in the range of between about 300 grams per square meter and about 600 grams per square meter.

10. The air filter of claim 9, wherein the weight of said flax material, formed as said sheet, is about 450 grams per square meter.

11. The air filter of claim 5, wherein said grass-based fibrous material comprises miscanthus which has been cut into shivs.

12. The air filter of claim 5, wherein said grass-based fibrous material comprises miscanthus which has been milled into shivs.

13. The air filter of claim 5, wherein said grass-based fibrous material comprises miscanthus which includes shivs having a length of about five millimeters to about fifteen millimeters.

14. The air filter of claim 13, wherein the shivs contain the entire miscanthus stock including the outer epidermis, pith, leafy part, epithelial and parenchyma cells, fibers, and cortex.

15. The air filter of claim 5, wherein said grass-based fibrous material comprises miscanthus, and wherein said sheet is formed from miscanthus pulp.

16. The air filter of claim 15, wherein said sheet is felted from said pulp.

17. The air filter of claim 1, further comprising a flow-through support member positioned in said generally open central area in contacting relation with said air filtering member.

18. The air filter of claim 17, wherein said flow-through support member comprises support portions spanning across said generally open central area.

19. The air filter of claim 18, wherein said support portions comprise cross-braces.

20. The air filter of claim 17, wherein said flow-through support member comprises a substantially rigid mesh.

21. The air filter of claim 17, wherein said flow-through support member is made from a decomposable type of plastic material.

22. The air filter of claim 21, wherein said decomposable type of plastic material comprises polylactic acid (PLA).

23. The air filter of claim 1, wherein said frame comprises an upstream portion and a downstream portion, and wherein said air filtering member of decomposable organic fibrous material is disposed and securely retained between said upstream portion and said downstream portion of said frame.

24. The air filter of claim 23, wherein one of said upstream portion and said downstream portion has a plurality of connector posts and the other of said upstream portion and said downstream portion has an equal plurality of receiving sockets positioned, shaped and dimensioned to receive and retain said connector posts therein.

25. The air filter of claim 1, wherein said frame is made from a decomposable type of plastics material.

26. The air filter of claim 25, wherein said plastics material comprises comprising polylactic acid (PLA).

27. A method of manufacturing an air filter, said method comprising the steps of:
reducing stocks of miscanthus into shivs;
initially soaking a batch of said shivs of said miscanthus in water;
placing the batch of soaked miscanthus into a container for subsequent cooking;
adding an amount of water into said container such that the batch of miscanthus is covered by said water;
adding an amount of sodium bicarbonate into said water, thereby producing a mixture of water, miscanthus and sodium bicarbonate;
boiling the mixture in the container;
cooling the mixture;
straining the miscanthus from the mixture;
rinsing the miscanthus with water;
blending the rinsed miscanthus with water until the miscanthus and water form a pulp;
adding a further amount of water to a receiving bin;
adding the pulped miscanthus into the water in the receiving bin;
sieving out the pulp from the water;
distributing the pulp generally uniformly to form a sheet of pulped miscanthus;
placing the resulting sheet of pulped miscanthus onto a tray;
drying the sheet of pulped miscanthus; and
securing said miscanthus sheet to a frame having a perimeter portion and a generally open central area.

28. The method of claim 27, wherein the step of reducing said miscanthus stocks into shivs comprises milling said miscanthus stocks into shivs.

29. The method of claim 27, wherein the step of reducing said stocks of miscanthus into shivs comprises reducing said stocks of miscanthus into shivs having a length of about five millimeters to about fifteen millimeters.

30. The method of claim 28, wherein the milled shivs contain the entire miscanthus stock including the outer epidermis, pith, leafy part, epithelial and parenchyma cells, fibers, and cortex.

31. The method of claim 27, wherein the step of blending the rinsed miscanthus with water, until the miscanthus and water form a pulp, is done to a ratio of about 1:1.

32. The method of claim 27, wherein the step of sieving out the pulp from the water is performed using a deckle screen.

33. The method of claim 27, further comprising a step of applying a fire retardant material to said sheet of pulped miscanthus.
